(19) United States
(12) Patent Application Publication
(10) Pub. No.: US 2014/0290131 A1
(43) Pub. Date: Oct. 2, 2014

(54) Growth Media Heating Apparatus for a Plant Propagation Container

(71) Applicant: STEVEN L. INSKEEP, URBANA, OH (US)

(72) Inventor: STEVEN L. INSKEEP, URBANA, OH (US)

(21) Appl. No.: 13/851,193

(22) Filed: Mar. 27, 2013

(51) Int. Cl. A01B 77/00

(52) U.S. Cl. CPC A01B 77/00
USPC 47/1.42

(57) ABSTRACT

Apparatus for heating the soil or other growth media in a plant propagation container, including a set of low-voltage silicone-encased heating elements embedded directly in the growth media. The silicone heating elements are sturdy and inherently waterproof, as they are designed to operate in harsh, high moisture industrial environments, and placing them in the growth media itself dramatically improves the heating efficiency and effectiveness. And being low voltage devices, typically 12 VDC, the risk of electrical shock to workers is substantially eliminated, even should the electrical cords become damaged by abrasion or misuse. Preferably, the apparatus includes a set of heating elements, a DC power supply for developing the DC operating voltage for the heating elements, and a thermostat for regulating the amount of heat produced by the heating elements.

### RELATED APPLICATIONS

This application claims priority based on the Provisional Patent Application No. 61/759,485, filed Feb. 1, 2013.

### TECHNICAL FIELD

The present invention relates to an apparatus for heating the soil or other growth media in a plant propagation container, and more particularly to a low-voltage apparatus including at least one in-soil heating element regulated by a thermostat.

### BACKGROUND OF THE INVENTION

Propagation of plants in cool ambient environments can be significantly improved by heating the soil or other growth media in the plant propagation containers. Ordinarily, this is achieved by placing electrical heating pads or seed heating mats under the plant propagation containers. While this approach can effectively heat a shallow layer of growth media, as in a seedbed, it cannot effectively or efficiently heat a larger quantity of media as is typically used in, say, a 3-to-5 gallon propagation container. Part of the problem is the sheer quantity of growth media and its distance from the heat source, but also the fact that many kinds of growth media are thermally insulative, with a temperature coefficient of 0.6 or higher. Furthermore, since heating pads are powered by 120 VAC, they present an inherent risk of electrical shock to persons handling the pads and containers should the insulation on the pads or their electrical cords get damaged during use, especially considering the high moisture environment in which they are used. Accordingly, what is needed is a safer and more effective and efficient way of heating the soil or other growth media in a plant propagation container.

### SUMMARY OF THE INVENTION

The present invention provides a new and improved apparatus for heating the soil or other growth media in a plant propagation container, including a set of low-voltage silicone-encased heating elements embedded directly in the growth media near the root mass the plants or cuttings planted in the growth media. The silicone heating elements are sturdy and inherently waterproof, as they are designed to operate in harsh, high moisture industrial environments, and burying them in the growth media in proximity to the root zone of the plants dramatically improves the heating efficiency and effectiveness. And being low voltage devices, typically 12 VDC, the risk of electrical shock to workers is substantially eliminated, even should the heating elements or electrical cords become damaged by abrasion, wear or misuse.

Preferably, the apparatus includes one or more heating elements, a DC power supply for developing the DC operating voltage for the heating elements, and a thermostat for regulating the amount of heat produced by the heating elements. The thermostat is powered by AC line voltage, and includes a switched outlet that powers the DC power supply. Conveniently, the DC power supply may be an LED lighting driver.

### BRIEF DESCRIPTION OF THE DRAWINGS

FIG. 1 is an illustration of the heating apparatus of this invention, including a thermostat device, a DC power supply, and a silicone-encased heating element embedded in the growth media of a plant propagation container.

### DESCRIPTION OF THE PREFERRED EMBODIMENT

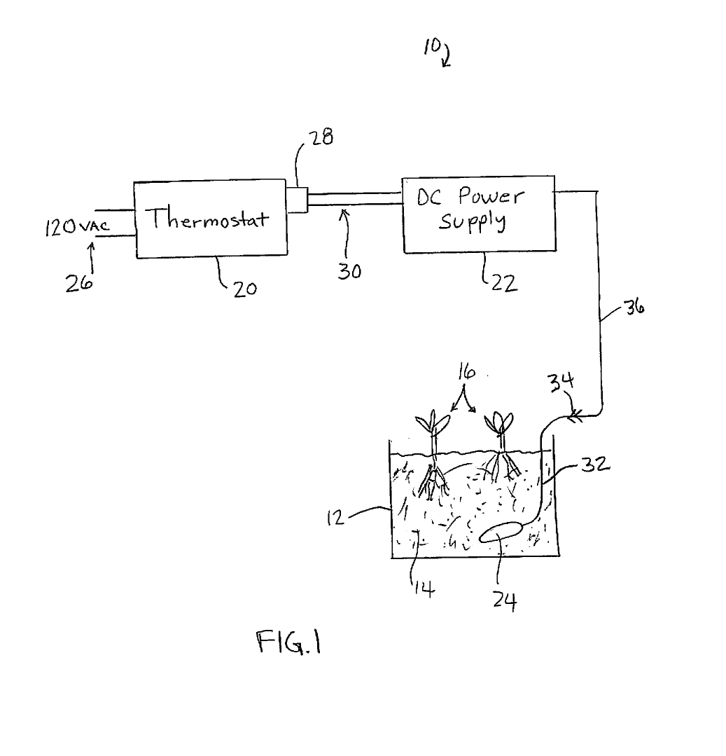

Referring to FIG. 1, the reference numeral 10 generally designates a low-voltage plant media heating apparatus according to this invention. As illustrated in FIG. 1, the apparatus 10 is designed to heat the growth media 14 within a plant propagation container 12 to promote rapid growth of young plants or cuttings 16 planted in the growth media 14. The growth media may comprise ordinary potting soil and/or other media such as coconut fiber, glass beads, rock wool, expanded clay pellets, sand, gravel, composite, perlite, peat moss, for example. The apparatus 10 can be applied to any size container 12 or quantity of growth media 14, but is particularly applicable to relatively large containers 12 and quantities of growth media 14 that cannot be effectively or efficiently heated with conventional heating pads or seed heating mats.

In general, the apparatus 10 includes a thermostat 20, a DC power supply 22, and one or more silicone-encased heating elements 24 embedded in the growth media 14 to be heated. The thermostat is powered by a 120VAC input 26, and includes a switched 120 VAC outlet 28 that is alternately activated and deactivated under the control of the thermostat circuitry to regulate the duty-cycle of a heater plugged into the switched outlet 28. The thermostat circuitry is responsive to a user-desired heat setting, and may include a temperature probe (not shown) to sense the temperature of the heated media. An example of a suitable commercially available thermostat is the MTPRTC, available for example, from HydrofarmUSA. The DC power supply 22 is disposed remote from the propagation container 12, receives a 120 VAC input from the switched outlet 28 of thermostat 20, and converts the 120 VAC to 12 VDC at output 36. Power supplies meeting this description are commonly used to power LED lighting and solid-state devices such as closed-circuit TV cameras, for example. An example of a suitable commercially available DC power supply is available for example, from Radio Shack. The silicone-encased heating element 24 is provided with integral lead wires 32 encased in a waterproof jacket, and a waterproof electrical coupling 34 is used to couple the heating element lead wires 32 to the DC output 36 of DC power supply 22. While only one heating element 24 is depicted in the illustration of FIG. 1, it will be understood that more than one heating element can be embedded in a given quantity of growth media 14, and the heat rating and shape of the heating elements 24 may be selected for a given application. Suitable silicone rubber encased heating elements are commercially available, for example, from Durex Industries, Inc., in Cary, Ill.

Key to the heating efficiency and efficacy of the apparatus of the present invention is the placement of the heating elements 24 directly in the growth media 14, preferably in proximity to the root zone of the plants 16 where the heating is most beneficial. The growth media 14, by its very nature and composition, is highly resistive to changes in its temperature, having a temperature coefficient of approximately 0.60. As a result, the ability of a heat source to change the temperature of growth media significantly decreases with the distance from the heat source. Consequently, the conventional approach of placing a heating pad or seed heating mat under a propagation container 12 is particularly inefficient and ineffective in applications where the container 12 holds a sizable mass of growth media 14. But with the apparatus of the present invention, the heat source (heating element 24) is placed within the bulk of the growth media 14 at the root zone of the plants 16 to much more effectively and efficiently accomplish the desired result of a more favorable root environment.

The waterproof and low voltage aspects of the heating elements 24 are also key to the performance of the apparatus 10 since the heating elements 24 are immersed in the growth media 14, which is frequently saturated with moisture. Even if abrasion, wear or misuse compromises the insulation barriers covering the heating element 24, its lead wires 32, the connector 34 or the power supply output 36, there is no risk of injury from electrical shock to a worker handling the container 12, the growth media 14 of the components of apparatus 10.

In summary, the apparatus of the present invention provides an efficient, effective and safe means of increasing the temperature of root zone growth media 14 in a propagation container 12 of any size or shape to promote improved plant growth. There is little or no wasted heat, which lowers overall energy consumption and operating costs, compared to the conventional approach of placing heating mats under the container 12

While the present invention has been described with respect to the illustrated embodiment, it is recognized that numerous modifications and variations in addition to those mentioned herein will occur to those skilled in the art. For example, and so on. Accordingly, it is intended that the invention not be limited to the disclosed embodiment, but that it have the full scope permitted by the language of the following claims.

1. Heating apparatus for growth media in a plant propagation container, comprising:
at least one waterproof heating element buried in the growth media in proximity to a root zone of a plant or cutting planted in the growth media;
a DC power supply disposed remote from the propagation container for developing a DC voltage output; and
waterproof electrical conductors for electrically coupling the DC output voltage of said DC power supply to said waterproof heating element to efficiently and effectively increase a temperature of the growth media in proximity to said root zone.

2. The heating apparatus of claim 1, where:
said DC output voltage a voltage sufficiently low that there is substantially no risk of electrical shock to persons contacting the container, the electrical conductors and the heating element, even if the conductors or heating elements are damaged from wear or abuse.

3. The heating apparatus of claim 2, where:
said DC output voltage is approximately 12VDC.

4. The heating apparatus of claim 1, where:
said waterproof heating elements are silicone encased heating elements.

5. The heating apparatus of claim 1, further comprising:
a thermostat for regulating an amount of heat produced by the heating elements.

6. The heating apparatus of claim 5, where:
said thermostat is powered by AC line voltage, and includes a switched outlet that powers said DC power supply.

7. The heating apparatus of claim 1, where:
said DC power supply is a LED lighting driver.
